(19) United States
(12) Patent Application Publication
(10) Pub. No.: US 2011/0286756 A1
(43) Pub. Date: Nov. 24, 2011

(54) IMAGE FORMING APPARATUS

(75) Inventors: Akinobu Nishikata, Abiko-shi (JP); Takayuki Fujii, Tokyo (JP); Hiroshi Matsumoto, Toride-shi (JP); Hidenori Matsumoto, Kashiwa-shi (JP); Katsuya Nakama, Kashiwa-shi (JP)

(73) Assignee: CANON KABUSHIKI KAISHA, Tokyo (JP)

(21) Appl. No.: 13/098,612

(22) Filed: May 2, 2011

(30) Foreign Application Priority Data
May 18, 2010 (JP) 2010-114528

(51) Int. Cl. G03G 15/20

(52) U.S. Cl. 399/45

(57) ABSTRACT

An image forming apparatus, which forms an image on a recording medium, including: an image bearing member; a toner image forming portion configured to form a toner image on the image bearing member; a transfer device configured to transfer the toner image formed on the image bearing member to the recording medium; a fixing device configured to pressurize and heat the recording medium to which the toner image is transferred, to fix the toner image on the recording medium; and a control circuit portion configured to control a temperature of the fixing device, wherein the control circuit portion controls a temperature of the fixing device for a first recording medium considering a temperature of the fixing device for a second recording medium to be fixed after the first recording medium.

### BACKGROUND OF THE INVENTION

1. Field of the Invention

The present invention relates to an image forming apparatus capable of controlling a temperature of a fixing device.

2. Description of the Related Art

Conventionally, in an image forming apparatus in which a fixing device pressurizes and heats a toner image transferred to recording paper for heat fixing, for the purpose of fixing on various types of recording paper, the fixing temperature of the fixing device is changed over to a fixing temperature suitable for the type and the thickness of the recording paper. In a case where different types of recording paper are used in a mixed manner in one job, the productivity is reduced by the changeover delay time generated in the fixing temperature changeover.

To address this problem, there has been proposed a technology in which the order of print jobs is changed so that print jobs using the same type of recording paper are processed successively, to thereby reduce the changeover delay time and suppress the reduction in productivity (Japanese Patent Application Laid-Open Nos. 2002-251106 and 2003-280461 and U.S. Pat. No. 7,010,240). This technology is suitable for a case where the recording paper to be used is switched by unit job. However, in the case where multiple types of recording paper are used in one job, when the output order of the recording paper is changed in order to process the same type of recording paper successively, the pages of the product become out of order.

Meanwhile, there has also been proposed a technology in which the nip width of the rollers of the fixing device is changed without the fixing temperature changeover, to thereby control the amount of heat supplied to the recording paper (Japanese Patent Application Laid-Open No. 2001-154525). In this case, there is a need for a configuration for changing the nip width between the fixing roller and the pressure roller. Such configuration is complex and leads to an increase in cost.

Conventionally, there are cases where plain paper and coat paper are used in a mixed manner to produce one product in one print job. Examples of the plain paper may include thick paper, thin paper, and recycled paper. Such paper sheets are generally handled as paper sheets that are the same in surfaceness and different in basis weight. Examples of the coat paper may include single-sided coat paper and double-sided coat paper. In a case where multiple recording paper sheets of different types and thicknesses are used in one print job, for the purpose of appropriately fixing the toner image on the recording paper, for each type of recording paper, it is necessary to change over a temperature to a target temperature of the fixing device that is suitable for the recording paper. However, when the target temperature of the fixing device is changed every time the recording paper is switched in one print job, the productivity is reduced. In conventional technologies, there is a problem in that, in a case where multiple recording paper sheets of different types are used in one job, the number of target temperature changeovers of the fixing device is increased, which leads to reduced productivity.

### SUMMARY OF THE INVENTION

It is an object of the present invention to provide an image forming apparatus capable of reducing the number of target temperature changeovers of a fixing device as compared to conventional technologies in a case where multiple types of recording paper are used in one print job.

In order to attain the above-mentioned object, the present invention provides an image forming apparatus, which forms an image on a recording medium, including: an image bearing member; a toner image forming portion configured to form a toner image on the image bearing member; a transfer device configured to transfer the toner image formed on the image bearing member to the recording medium; a fixing device configured to pressurize and heat the recording medium to which the toner image is transferred, to fix the toner image on the recording medium; and a control circuit portion configured to control a temperature of the fixing device, wherein the control circuit portion controls a temperature of the fixing device for a first recording medium considering a temperature of the fixing device for a second recording medium to be fixed after the first recording medium.

Further features of the present invention will become apparent from the following description of exemplary embodiments with reference to the attached drawings.

### BRIEF DESCRIPTION OF THE DRAWINGS

FIG. 1 is a longitudinal sectional view of an image forming apparatus.

FIG. 2 is a block diagram of a control portion of the image forming apparatus.

FIGS. 3A, 3B, 3C, and 3D are explanatory views of an operating portion.

FIGS. 4A and 4B are tables showing target temperatures of a tandem fixing device.

FIG. 5 is a flow chart illustrating a process of determining a target temperature of a first fixing portion.

FIG. 6 is a table showing information used in the process of determining the target temperature.

FIGS. 7A, 7B, 7C, and 7D are diagrams each illustrating execution time for a job involving target temperature changeovers.

FIG. 8 is a flow chart illustrating target temperature changeover control.

### DESCRIPTION OF THE EMBODIMENTS

Hereinafter, there is described an image forming apparatus in which a temperature of a fixing device is controlled according to an embodiment of the present invention. The image forming apparatus is an electrophotographic image forming apparatus for forming an image on a recording medium by using an electrophotographic image forming process. Examples of the electrophotographic image forming apparatus include an electrophotographic copier, an electrophotographic printer (such as a color laser beam printer and a color LED printer), a multifunction printer (MFP), a facsimile machine, and a word processor.

The electrophotographic image forming apparatus (hereinafter, referred to as an image forming apparatus) is not limited to an image forming apparatus for forming a black and white image, and may include a color image forming apparatus. In this embodiment, an example in which a copier is used as the image forming apparatus is described with reference to the accompanying drawings.

(Image Forming Apparatus)

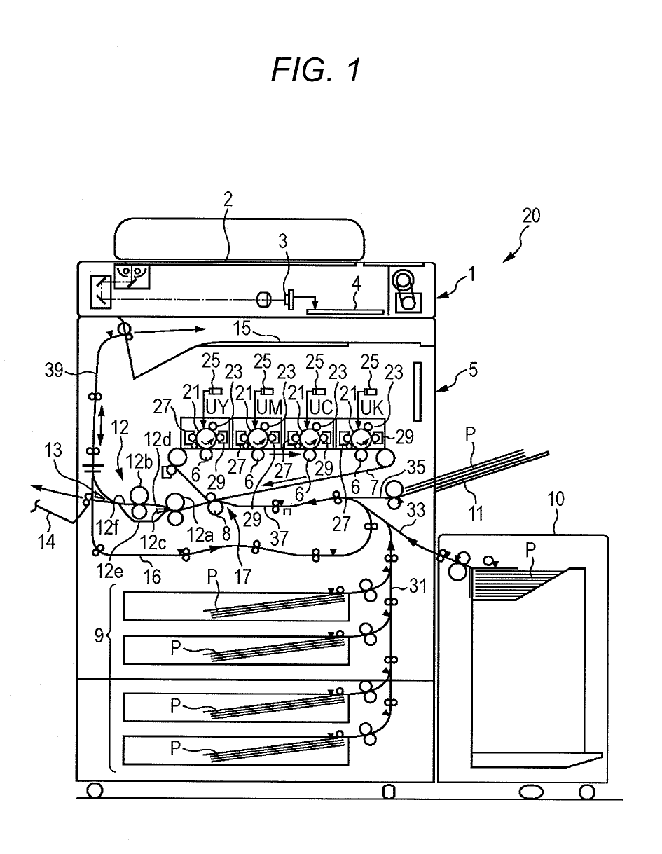

FIG. 1 is a longitudinal sectional view of an electrophotographic full-color copier 20, which is an example of the image forming apparatus according to the present invention.

The electrophotographic full-color copier (hereinafter, referred to as an image forming apparatus) 20 includes an image reading portion 1 and an image forming portion 5. The image reading portion 1 photoelectrically reads a color image of an original placed on a platen glass 2 as a color separation image signal (hereinafter, referred to as image information) by a full-color sensor (CCD) 3. The image information is subjected to an image processing in an image processing portion 4 and transmitted as a digital signal to the image forming portion 5.

The image forming portion 5 includes a first image forming unit UY, a second image forming unit UM, a third image forming unit UC, and a fourth image forming unit UK. The four image forming units UY, UM, UC, and UK are arranged in tandem. Each of the four image forming units includes an electrophotographic photosensitive drum (hereinafter, referred to as a photosensitive drum) 21. The photosensitive drum (an image bearing member) 21 rotates in a direction (a counterclockwise direction) indicated by the arrow of FIG. 1. Around the photosensitive drum 21, a charging roller 23, an exposure unit 25, a developing unit 27, a primary transfer roller 6, and a cleaning device 29 are provided in this order in the rotation direction of the photosensitive drum 21. The charging roller 23, the exposure unit 25, and the developing unit 27 serve as a toner image forming portion configured to form a toner image on the image bearing member. Under the image forming units UY, UM, UC, and UK, an intermediate transfer belt 7 is provided to be rotatable in a direction (a clockwise direction) indicated by the arrow of FIG. 1. The primary transfer roller 6 brings the intermediate transfer belt 7 into contact with the photosensitive drum 21 to form a primary transfer portion between the intermediate transfer belt 7 and the photosensitive drum 21. A secondary transfer roller 8 is provided so as to be brought into contact with the intermediate transfer belt 7. The secondary transfer roller 8 is brought into contact with the intermediate transfer belt 7 to form a secondary transfer portion between the intermediate transfer belt 7 and the secondary transfer roller 8. The primary transfer rollers 6, the intermediate transfer belt 7, and the secondary transfer roller 8 constitute a transfer device 17 configured to transfer the toner image formed on the photosensitive drum 21 to a sheet of recording paper (a recording medium). In this embodiment, the transfer device 17 includes the intermediate transfer belt 7, but the present invention is not limited thereto. The transfer device 17 may have a configuration including a transfer belt that transports the recording paper in contact with the photosensitive drum 21, and a transfer member configured to transfer the toner image directly from the photosensitive drum 21 to the recording paper on the transfer belt. Further, the recording paper may also be referred to as a sheet, a paper sheet, or a transfer material.

In a lower portion of the image forming apparatus 20, multiple sheet feeding cassettes 9 containing recording paper P are provided. Further, a sheet feeding deck 10 containing the recording paper P is connected to the image forming apparatus 20. A manual sheet feeding tray 11 is provided on a side portion of the image forming apparatus 20. The recording paper P in the sheet feeding cassette 9 is transported to the secondary transfer roller 8 via a transport path 31 and a transport path 37. The recording paper P in the sheet feeding deck 10 is transported to the secondary transfer roller 8 via a transport path 33 and the transport path 37. The recording paper P on the manual sheet feeding tray 11 is transported to the secondary transfer roller 8 via a transport path 35 and the transport path 37.

A tandem fixing device 12 is provided downstream of the secondary transfer roller 8 in a recording paper transport direction. The tandem fixing device 12 includes a first fixing portion 12a and a second fixing portion 12b. The second fixing portion 12b is provided downstream of the first fixing portion 12a in the recording paper transport direction. Each of the first fixing portion 12a and the second fixing portion 12b has a pair of rollers. The pair of rollers include a heating roller and a pressure roller. A flapper 12c configured to switch the transport of the recording paper between transport paths is provided downstream of the first fixing portion 12a. The flapper 12c switches between a transport path 12d from the first fixing portion 12a to the second fixing portion 12b and a transport path 12e bypassing the second fixing portion 12b. The transport path 12e bypassing the second fixing portion 12b joins into a transport path 12f extending from the second fixing portion 12b downstream of the second fixing portion 12b.

A flapper 13 is provided downstream of the tandem fixing device 12 in the recording paper transport direction. The flapper 13 switches between the transport path to a face-up discharge tray 14 provided on a side portion of the image forming apparatus 20 and a transport path 39 to a face-down discharge tray 15 provided above the image forming portion 5.

For the purpose of forming an image on the back side of the recording paper P, there is provided a retransport path 16 configured to transport the recording paper P again to the secondary transfer roller 8. The retransport path 16 extends from the downstream of the flapper 13 to the upstream of the transport path 37.

(Image Forming Process)

In order to form an image on the recording medium P, the photosensitive drum 21 is first rotated in synchronization with the rotation of the intermediate transfer belt 7. The surface of the photosensitive drum 21 is uniformly charged by the charging roller 23. Based on the image information transmitted from the image reading portion 1 to the image forming portion 5, the exposure unit 25 of the first image forming unit UY irradiates the uniformly charged surface of the photosensitive drum 21 with a laser beam to form a yellow electrostatic latent image on the photosensitive drum 21. The developing unit 27 of the first image forming unit UY uses a developer (hereinafter, referred to as toner) of yellow to develop the electrostatic latent image into a yellow toner image. Similarly, the second image forming unit UM, the third image forming unit UC, and the fourth image forming unit UK form a magenta toner image, a cyan toner image, and a black toner image on the surfaces of the photosensitive drums 21 thereof at predetermined control timings, respectively.

The yellow toner image, the magenta toner image, the cyan toner image, and the black toner image formed on the surfaces of the photosensitive drums 21 are sequentially transferred and superimposed on the intermediate transfer belt 7 by the respective primary transfer rollers 6. Therefore, an unfixed full-color toner image is formed on the surface of the intermediate transfer belt 7 by superimposing the four toner images. The superimposed full-color toner image is transferred collectively by the secondary transfer roller 8 on the surface of the recording paper P transported from the sheet feeding cassettes 9, the sheet feeding deck 10, or the manual sheet feeding tray 11 at a predetermined control timing to the secondary transfer roller 8.

The recording paper P is separated from the intermediate transfer belt 7 and introduced to the tandem fixing device 12. The recording paper P is nipped and transported by a fixing nip portion of the first fixing portion 12a of the tandem fixing device 12 or fixing nip portions of the first fixing portion 12a and the second fixing portion 12b. In the nipping and transporting process, the unfixed full-color toner image is fused and color-mixed by heat and pressure to be fixed as a full-color image on the surface of the recording paper P. For example, in a case where the recording paper P is a thick sheet, the flapper 12c of the tandem fixing device 12 switches the transport path to the transport path 12d so that the recording paper P passes through both the first fixing portion 12a and the second fixing portion 12b. In a case where the recording paper P is a thin sheet, the flapper 12c switches the transport path to the transport path 12e so that the recording paper P passes through only the first fixing portion 12a and does not pass through the second fixing portion 12b. In this manner, the flapper 12c switches the transport path depending on the type of recording paper P so that the recording paper P is transported through both the first fixing portion 12a and the second fixing portion 12b or through only the first fixing portion 12a. The recording paper P on which the toner image is fixed by the tandem fixing device 12 is discharged to the face-up discharge tray 14 or the face-down discharge tray 15 by switching the transport path by the flapper 13.

In a case where a two-side print mode is selected, the recording paper P having an image fixed on a front surface (the first surface) by the tandem fixing device 12 is sent once by the flapper 13 into the transport path 39 leading to the face-down discharge tray 15. After a trailing end of the recording paper P passes the flapper 13, the recording paper P is switch-back transported to be introduced to the retransport path 16. The recording paper P is transported from the retransport path 16 to the transport path 37 and introduced again to the secondary transfer roller 8 after the front surface and a back surface of the recording paper P are reversed. In this manner, a toner image is secondarily transferred to the back surface (the second surface) of the recording paper P. Thereafter, as in the case of the one-side printing, the recording paper P is introduced to the tandem fixing device 12, and the recording paper P having the image formed on the back surface is discharged to the face-up discharge tray 14 or the face-down discharge tray 15.

(Control Portion)

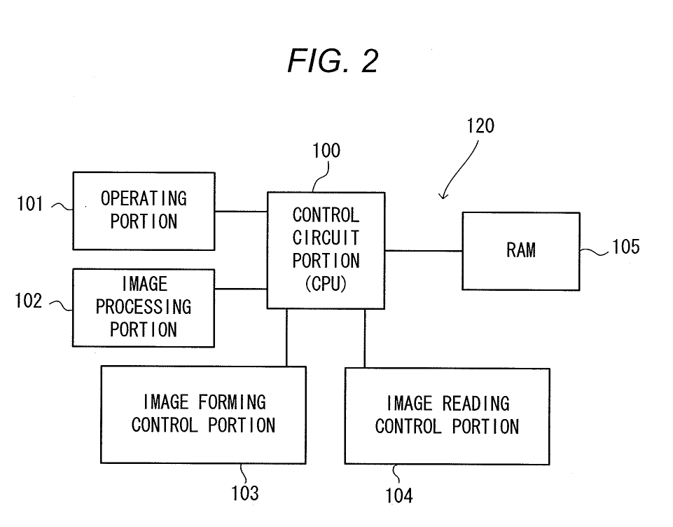

FIG. 2 is a block diagram of a control portion 120 of the image forming apparatus 20.

The control portion 120 includes a control circuit portion (CPU) 100, an operating portion 101, an image processing portion 102, an image forming control portion 103, an image reading control portion 104, and a random access memory (RAM) 105. The control circuit portion 100 mainly executes a program. The operating portion 101 is electrically connected to the control circuit portion 100 and receives an input from a user. The image processing portion 102 is electrically connected to the control circuit portion 100 and processes the image information from the image reading portion 1 or the image information constituted of a page description language (PDL). The image forming control portion 103 is electrically connected to the control circuit portion 100 and controls the image forming portion 5 of the image forming apparatus 20. The image reading control portion 104 is electrically connected to the control circuit portion 100 and controls the image reading portion 1. The RAM 105 is electrically connected to the control circuit portion 100 and constitutes a temporary memory for arithmetic processing.

The user may input and set various kinds of conditions and information on the image forming apparatus 20 to the control circuit portion 100 through the operating portion 101. The user may also input paper information to the control circuit portion 100 through the operating portion 101. The user may further select a sheet feeding portion (the sheet feeding cassettes 9, the sheet feeding deck 10, and the manual sheet feeding tray 11) or select a destination of discharge (the face-up discharge tray 14 and the face-down discharge tray 15) through the operating portion 101.

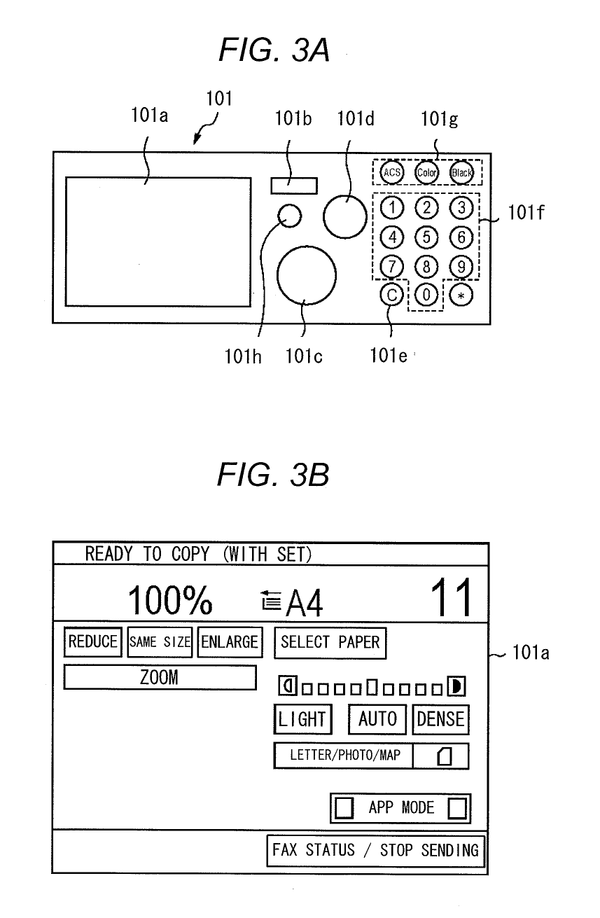

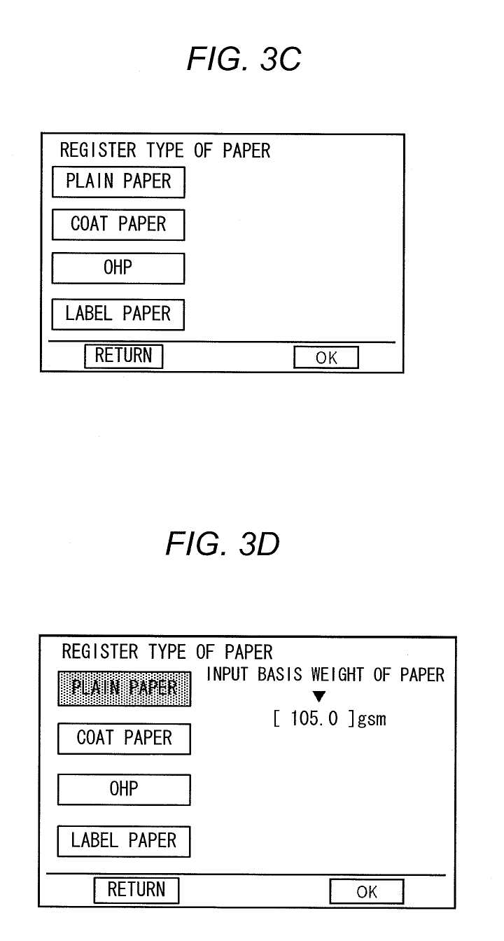

FIGS. 3A to 3D are explanatory views of the operating portion 101. FIG. 3A is a plan view of the operating portion 101 in this embodiment.

The operating portion 101 includes a touch panel display 101a. FIG. 3B is a view illustrating a display of the touch panel display 101a. The touch panel display 101a usually displays the number of copies, the selected paper size, the magnification, the copy density, the finishing, and the one-side/two-side mode. The operating portion 101 includes a reset key 101b for resetting the copy mode to the normal mode. A start key 101c is used to start a copy operation. A stop key 101d is used to stop the copy operation. A clear key 101e is used to reset the input numerical value to 1. Numeric keys 101f are used to set the number of copies. Color mode selection keys 101g include an “ACS” key, a “Color” key, and a “Black” key. Any one of the keys is selected and turned on. The “ACS” key is used to automatically discriminate whether the original is color or black and white and output a color image when the original is color or a black and white image when the original is black and white. The “Color” key is used to output a color image without discriminating the original. The “Black” key is used to output a black and white image without discriminating the original.

When a user mode key 101h is pressed, the user mode key 101h allows a menu to be selected so that various kinds of settings and adjustments may be performed on the image forming apparatus 20. For example, a menu may be selected for performing settings for a printing such as “Register type of paper”, initial settings for the image forming apparatus 20, such as “Timer setting in low power consumption mode”, and settings for an adjustment such as “Clean wire”.

When “Register type of paper” is selected, the touch panel display 101a displays a screen illustrated in FIG. 3C so that the type of recording paper to be used may be registered. For example, when “Plain paper” is selected, as illustrated in FIG. 3D, a screen for inputting the basis weight of the plain paper is displayed so that a numerical value may be input through the numeric keys 101f.

(Description of Target Temperatures of Fixing Device)

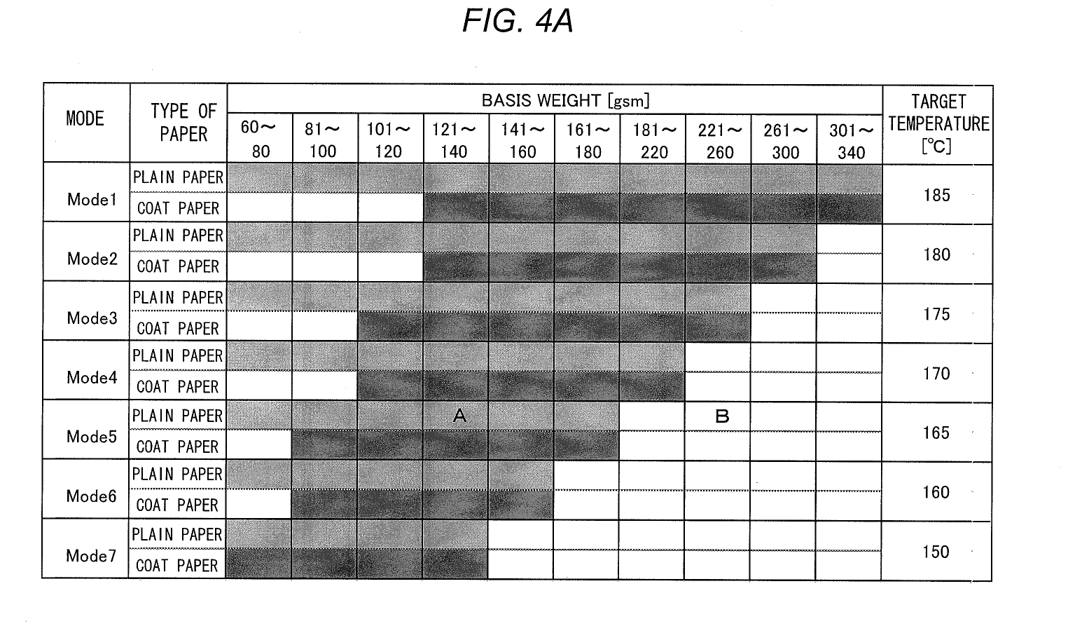

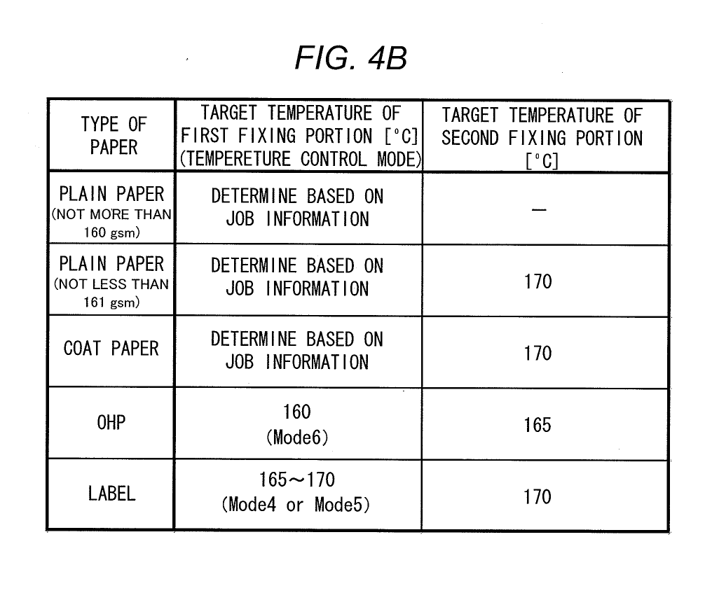

FIGS. 4A and 4B are tables showing target temperatures of the tandem fixing device 12.

In this embodiment, attention is given to the fact that ranges of target temperatures, in which the fixing device may perform fixing, may be set for respective types of recording paper. An overlap of the ranges of target temperatures for the types of recording paper is divided into multiple temperature control modes, and a target temperature is set for each of the temperature control modes. A target temperature of the first fixing portion 12a may be changed to multiple target temperatures. Each of the multiple target temperatures is usable for fixing on recording paper in a predetermined range of the basis weight. The predetermined ranges of basis weights for the multiple target temperatures have an overlap.

FIG. 4A shows the temperature control modes of the first fixing portion 12a. Seven types of temperature control modes Mode1 to Mode7 are set depending on the basis weights of the plain paper and the coat paper. The portion colored in light gray in each temperature control mode indicates a fixable range of basis weights of the plain paper. Similarly, the portion colored in dark gray in each temperature control mode indicates a fixable range of basis weights of the coat paper. Here, “gsm” is a unit of the basis weight of paper [g/m²]. For example, recording paper on which fixing may be performed in Mode2 is the plain paper having a basis weight in a range of 60 gsm to 300 gsm and the coat paper having a basis weight in a range of 121 gsm to 300 gsm. The target temperature in Mode2 is 180° C. Each target temperature is usable for fixing on the recording paper (plain paper and coat paper) in a predetermined range of basis weights.

FIG. 4B shows target temperatures of the first fixing portion 12a and the second fixing portion 12b for various types of paper including other types of paper than the plain paper and the coat paper in addition to the plain paper and the coat paper. For example, in a case of an overhead projector (OHP) sheet, the target temperature of the first fixing portion 12a is 160° C. (Mode6) and the target temperature of the second fixing portion 12b is 165° C. In a case of a label, the target temperature of the first fixing portion 12a is in a range of 165° C. to 170° C. (Mode4 or Mode5) and the target temperature of the second fixing portion 12b is 170° C. In a case of the plain paper having a basis weight not less than 161 gsm and the coat paper, the target temperature of the first fixing portion 12a is determined among Model through Mode7 of FIG. 4A (the method of determining the temperature control mode is to be described later) and the target temperature of the second fixing portion 12b is 170° C. In a case of the plain paper having a basis weight not more than 160 gsm, the target temperature of the first fixing portion 12a is determined among Mode1 through Mode7, but the target temperature of the second fixing portion 12b is not set because this plain paper does not pass through the second fixing portion 12b.

(Process of Determining Target Temperature of First Fixing Portion)

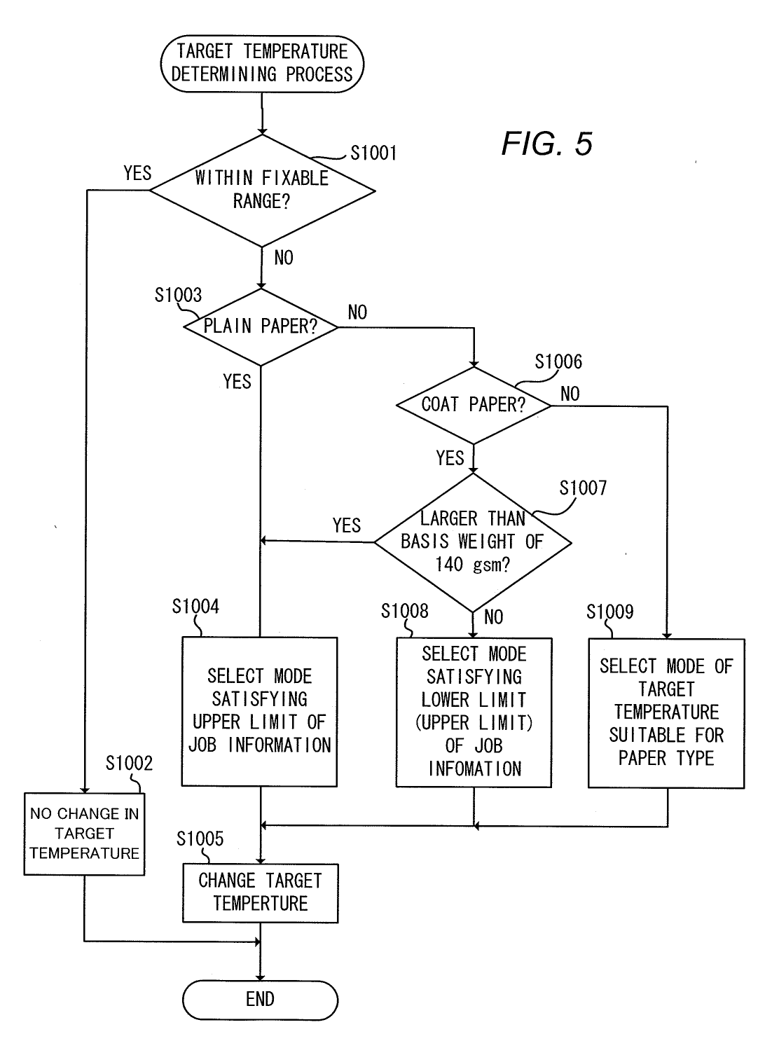

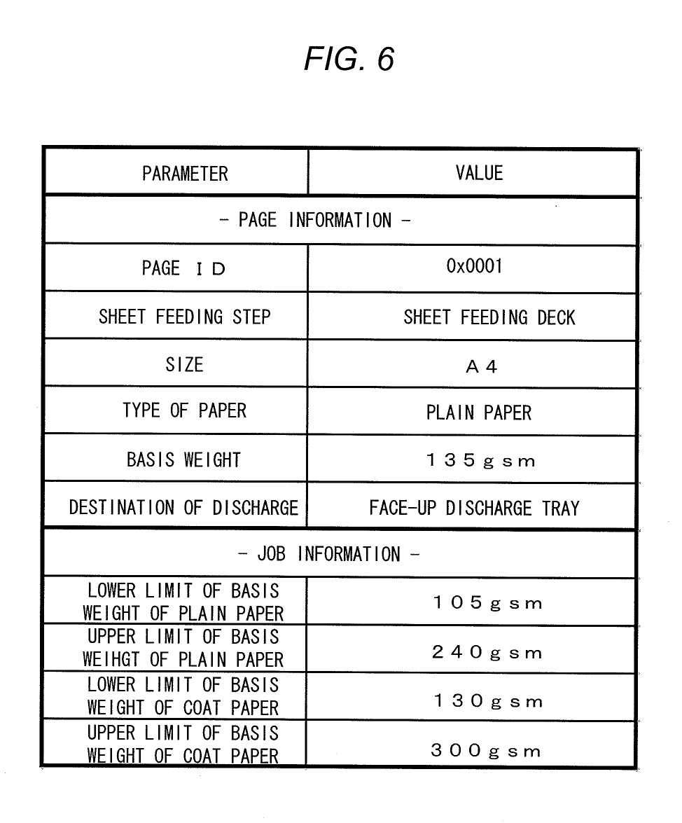

FIG. 5 is a flow chart illustrating a target temperature determining process for the first fixing portion 12a. The target temperature determining process for the first fixing portion 12a is performed for each page by the control circuit portion 100. A print job is input to the control circuit portion 100 through the operating portion 101 or an external device notifies the control circuit portion 100 of a print job. The print job contains the image information and paper quality information (material information). The paper quality information is contained in each of page information and job information of a print job. The page information contains the paper quality information on the recording paper for each page. The job information contains the paper quality information on multiple recording paper sheets to be used in the print job. The paper quality information contains information on the surfaceness of the recording paper and information on the basis weight of the recording paper. The information on the surfaceness of the recording paper is information indicating that the recording paper for the page to be printed is plain paper, coat paper, an OHP sheet, or a label. FIG. 6 is a table showing information used in the target temperature determining process. The control circuit portion 100 holds the page information containing attributes of each page and the job information containing attributes of each job as illustrated in FIG. 6. The control circuit portion 100 determines the target temperature of the first fixing portion 12a based on the information. The information is generated by a controller for managing job contents and print data of a print operation or by a print driver. For example, in this embodiment, the page information contains information on a page ID, a sheet feeding portion, and the size, type of paper, basis weight, and destination of discharge of the recording paper. The job information contains information on an upper limit of basis weight (the maximum basis weight) and a lower limit of basis weight (the minimum basis weight) for each type of the multiple recording paper sheets to be used in the print job. For example, in this embodiment, the job information contains information on a lower limit of basis weight of plain paper, an upper limit of basis weight of plain paper, a lower limit of basis weight of coat paper, and an upper limit of basis weight of coat paper. The lower limit of basis weight of plain paper indicates the minimum basis weight of the plain paper to be used in the job. The upper limit of basis weight of plain paper indicates the maximum basis weight of the plain paper to be used in the job. The lower limit of basis weight of coat paper indicates the minimum basis weight of the coat paper to be used in the job. The upper limit of basis weight of coat paper indicates the maximum basis weight of the coat paper to be used in the job.

When the target temperature determining process is started, the control circuit portion 100 first judges whether or not the type of paper of the page to be printed next is within a fixable range of the current temperature control mode (S1001). For example, the current temperature control mode is Mode5. At this time, when the type of paper of the page to be printed is plain paper having a basis weight of 135 gsm (“A” in FIG. 4A), the plain paper having the basis weight of 135 gsm is within the fixable range of the current temperature control mode Mode5 (YES in S1001). Therefore, the control circuit portion 100 judges that there is no change in target temperature (S1002), and ends the target temperature determining process. As another example, the current temperature control mode is Mode5 and the type of paper of the page to be printed is plain paper having a basis weight of 240 gsm (“B” in FIG. 4A). In this case, the plain paper having the basis weight of 240 gsm is not within the fixable range of the current temperature control mode Mode5 (NO in S1001), and hence the process proceeds to S1003. In S1003, the control circuit portion 100 judges whether or not the type of paper of the page to be printed is plain paper. When the type of paper is plain paper (YES in S1003), the process proceeds to S1004. Here, with regard to the plain paper, fixing on the plain paper on the side of the lower limit of basis weight (60 to 80 gsm) may be performed in all of the temperature control modes (Mode1 through Mode7) (FIG. 4A). Therefore, with regard to the plain paper that is not within the fixable range of the current temperature control mode Mode5, the target temperature of the first fixing portion 12a needs to be increased. Temperature control modes in which fixing on the plain paper having the basis weight of 240 gsm may be performed are Mode1, Mode2, and Mode3. In S1004, the control circuit portion 100 determines which of the temperature control modes Mode1, Mode2, and Mode3 is to be selected, based on the upper limit of basis weight (the maximum basis weight) notified as the job information (FIG. 6). For example, when the job information indicates that the upper limit of basis weight of plain paper is 240 gsm and that the upper limit of basis weight of coat paper is 300 gsm, a temperature control mode in which fixing on the coat paper at the upper limit of basis weight of 300 gsm, which is the higher upper limit, may be performed and which has a lower target temperature is selected. In other words, the control circuit portion 100 selects, from among the temperature control modes Mode1 and Mode2 in which fixing on the coat paper having the basis weight of 300 gsm may be performed, the temperature control mode with the lower target temperature, that is, Mode2. In this manner, in changing to the target temperature suitable for the next recording paper having a basis weight that is larger than the basis weight of the preceding recording paper, the control circuit portion 100 selects the target temperature with which fixing may also be performed on the recording paper at the upper limit of basis weight (the maximum basis weight) of the job information. Further, in a case where there are multiple target temperatures that are also usable for fixing on the recording paper at the upper limit of basis weight (the maximum basis weight) of the job information, the control circuit portion 100 selects the lowest target temperature of the multiple target temperatures. Next, the process proceeds to S1005. The control circuit portion 100 judges that the target temperature is to be changed (S1005) because there is a need to change the current temperature control mode Mode5 to a new temperature control mode Mode2, and ends the target temperature determining process.

In S1003, when the type of paper of the page to be printed is not plain paper (NO in S1003), the process proceeds to S1006. In S1006, the control circuit portion 100 judges whether or not the type of paper of the page to be printed is coat paper. When the type of paper is coat paper (YES in S1006), the process proceeds to S1007. In S1007, the control circuit portion 100 judges whether or not the basis weight of the page to be printed is larger than 140 gsm. When the basis weight of the page to be printed is larger than 140 gsm (YES in S1007), the target temperature of the first fixing portion 12a needs to be increased, and hence the process proceeds to S1004. In S1004, the control circuit portion 100 performs the above-mentioned process. For example, even if the type of paper of the page to be printed is coat paper and the basis weight is 240 gsm, the control circuit portion 100 selects the temperature control mode based on the upper limit of basis weight notified as the job information (FIG. 6). When the job information indicates that the upper limit of basis weight of plain paper is 240 gsm and that the upper limit of basis weight of coat paper is 300 gsm, the control circuit portion 100 selects the temperature control mode Mode2 in which fixing on the coat paper at the upper limit of basis weight of 300 gsm, which is the higher upper limit, may be performed. This selection may be performed so as to reduce the number of target temperature changeovers.

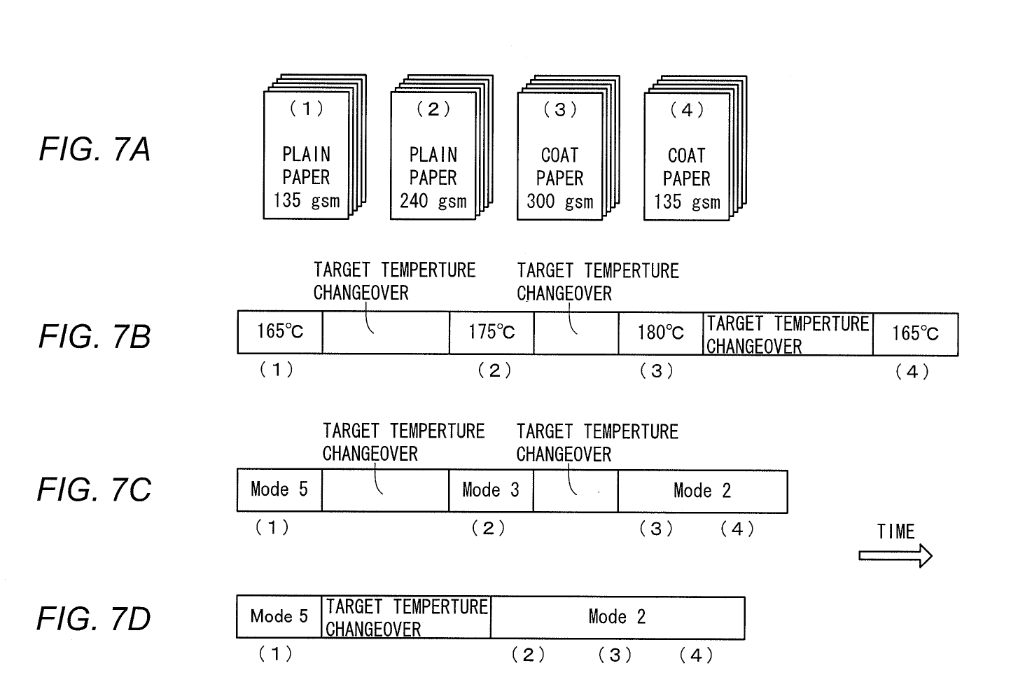

The reduction in number of the target temperature changeovers will be hereinafter described. FIGS. 7A to 7D are diagrams each illustrating execution time for a job involving the target temperature changeovers. For example, as illustrated in FIG. 7A, one job successively uses the recording paper including “(1) plain paper having a basis weight of 135 gsm”, “(2) plain paper having a basis weight of 240 gsm”, “(3) coat paper having a basis weight of 300 gsm”, and “(4) plain paper having a basis weight of 135 gsm” in the stated order. In the conventional technologies, for each paper quality of the recording paper (surfaceness and basis weight of paper), a changeover to the target temperature corresponding to the paper quality of the recording paper is performed and hence the target temperature changeovers are performed as illustrated in FIG. 7B. For “(1) the plain paper having the basis weight of 135 gsm”, the target temperature is changed over to 165° C. Next, for “(2) the plain paper having the basis weight of 240 gsm”, the target temperature is changed over to 175° C. Next, for “(3) the coat paper having the basis weight of 300 gsm”, the target temperature is changed over to 180° C. Next, for “(4) the plain paper having the basis weight of 135 gsm”, the target temperature is changed over to 165° C. In this manner, with the target temperature changeovers in the conventional technologies, the productivity of the job is significantly reduced.

FIG. 7C illustrates target temperature changeovers considering the fact that fixable ranges of multiple temperature control modes have an overlap. First, for “(1) the plain paper having the basis weight of 135 gsm”, the temperature control mode is changed over to Mode5 having the target temperature of 165° C. Next, for “(2) the plain paper having the basis weight of 240 gsm”, the temperature control mode is changed over to Mode3 having the target temperature of 175° C. Next, for “(3) the coat paper having the basis weight of 300 gsm”, the temperature control mode is changed over to Mode2 having the target temperature of 180° C. Next, for “(4) the plain paper having the basis weight of 135 gsm”, the target temperature is within the fixable range of Mode2 so that the need for a target temperature changeover may be eliminated. This may avoid the reduction in productivity of the job. By thus judging the overlap of the fixing temperature ranges of the recording paper to be used in the job and setting a fixing target temperature thereto, even if multiple recording paper sheets are used in the same job, the need for the fixing temperature changeovers may be eliminated and hence the reduction in productivity may be avoided.

FIG. 7D illustrates the target temperature changeovers according to this embodiment illustrated in FIG. 5. First, for “(1) the plain paper having the basis weight of 135 gsm”, the temperature control mode is changed over to Mode5 having the target temperature of 165° C. Next, for “(2) the plain paper having the basis weight of 240 gsm”, the target temperature is not within the fixable range of Mode5 and there is no overlap, and hence the target temperature changeover becomes necessary. At this time, the types of paper to be used in the succeeding printing are judged based on the job information. For example, it is judged that the types of paper to be used in the succeeding printing include pages of the plain paper having the basis weight of 240 gsm, the coat paper having the basis weight of 300 gsm, and the plain paper having the basis weight of 135 gsm. In this case, of the temperature control modes in which fixing may be performed on the coat paper having the basis weight of 300 gsm, a temperature control mode having a lower target temperature, that is, Mode2, is selected. In Mode2, fixing may be performed on “(2) the plain paper having the basis weight of 240 gsm”, “(3) the coat paper having the basis weight of 300 gsm”, and “(4) the plain paper having the basis weight of 135 gsm” that follow. Therefore, the target temperature changeover between “(2) the plain paper having the basis weight of 240 gsm” and “(3) the coat paper having the basis weight of 300 gsm” may be omitted. The continuous operation as illustrated in FIG. 7D may be performed without performing the target temperature changeover, with the result that the reduction in productivity due to the target temperature changeover may be avoided. When there is no overlap of the fixable ranges of the basis weights of the recording paper between the fixing temperature of the preceding recording paper and the fixing temperature of the succeeding recording paper, the fixing temperature changeover becomes necessary. However, even in such case, according to this embodiment, the number of the succeeding target temperature changeovers may be reduced, with the result that the time needed for the fixing temperature changeovers may be reduced and the reduction in productivity may be avoided.

In S1007 of FIG. 5, when the basis weight of the page to be printed is not larger than 140 gsm (NO in S1007), the target temperature needs to be reduced, and hence the process proceeds to S1008. In S1008, the control circuit portion 100 selects the temperature control mode based on the lower limit of basis weight of plain paper and the lower limit of basis weight of coat paper, which have been notified as the job information. In this embodiment, fixing on the plain paper on the side of the lower limit of basis weight may be performed no matter which temperature control mode is selected, and hence a temperature control mode satisfying the lower limit of basis weight of coat paper is selected.

For example, a case where the target temperature determining process is started under the following conditions will be described. The current temperature control mode is Mode2. The page to be printed is coat paper having a basis weight of 110 gsm. The job information indicates that the lower limit of basis weight of plain paper is 80 gsm, that the upper limit of basis weight of plain paper is 170 gsm, that the lower limit of basis weight of coat paper is 95 gsm, and that the upper limit of basis weight of coat paper is 170 gsm.

In this case, with the page to be printed being the coat paper having the basis weight of 110 gsm, the target temperature is not within the fixable range of the current temperature control mode Mode2 (NO in S1001). With the page to be printed being the coat paper having the basis weight of 110 gsm (NO in S1007), the control circuit portion 100 selects a temperature control mode from among the temperature control modes Mode5, Mode6, and Mode7 satisfying the lower limit of basis weight of coat paper of 95 gsm (S1008). In a case where the selection is made from among multiple temperature control modes (Mode5, Mode6, and Mode7 in the case where the lower limit of basis weight of coat paper is 95 gsm), the control circuit portion 100 selects the temperature control mode Mode5 or Mode6 having a larger lower limit of basis weight in the fixable ranges of the temperature control modes. In this manner, in changing to the target temperature suitable for the next recording paper having a basis weight that is smaller than that of the preceding recording paper, a target temperature with which fixing may also be performed on the recording paper at the lower limit of basis weight (the minimum basis weight) of the job information is determined. Further, the temperature control mode Mode5 also satisfying the upper limit of basis weight of plain paper of 170 gsm and the upper limit of basis weight of coat paper of 170 gsm is selected. Note that, in a case where there is no temperature control mode also satisfying the upper limit of basis weight of plain paper and the upper limit of basis weight of coat paper, a temperature control mode that is closer to the upper limit of basis weight of plain paper and the upper limit of basis weight of coat paper may be selected. For example, when the upper limit of basis weight of plain paper is 240 gsm and the upper limit of basis weight of coat paper is 300 gsm, neither Mode5 nor Mode6 satisfies the upper limits, but Mode5 is selected because Mode5 is closer to the upper limits. Next, the process proceeds to S1005. The current temperature control mode Mode2 needs to be changed over to the new temperature control mode Mode5. Therefore, the control circuit portion 100 judges that the target temperature is to be changed (S1005), and ends the target temperature determining process.

In S1006, when the page to be printed is not coat paper (NO in S1006), the process proceeds to S1009. In S1009, the control circuit portion 100 selects a temperature control mode that supports other types of paper than the plain paper and the coat paper. For example, when the type of paper of the page to be printed is a label, it can be seen from FIG. 4B that the suitable temperature control mode is Mode4 or Mode5, and hence Mode5 is selected considering the upper limit of the job information. The current temperature control mode Mode2 needs to be changed over to the new temperature control mode Mode5. Therefore, the control circuit portion 100 judges that the target temperature is to be changed (S1005), and ends the target temperature determining process.

With the control as described above, a temperature control mode that is suitable to the page to be printed and involves as small a number of target temperature changeovers as possible for the succeeding pages is selected.

(Description of Target Temperature Changeover Control)

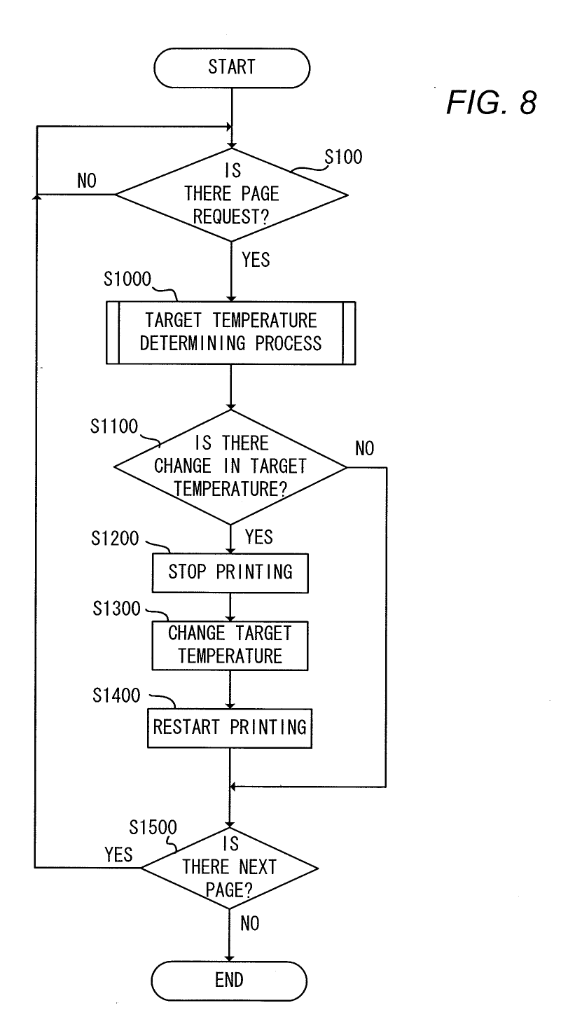

FIG. 8 is a flow chart illustrating target temperature changeover control. Referring to FIG. 8, control in a case where target temperature changeovers are performed at the time of printing will be described. The processing of this flow chart is also executed by the control circuit portion 100.

When the start key 101c is pressed to start the printing operation, the control circuit portion 100 judges whether or not there is a new page request (S100). When there is a new page request (YES in S100), the control circuit portion 100 performs the target temperature determining process described above (S1000). Then, the process proceeds to S1100, and when the target temperature determining process in the flow chart of FIG. 5 led to “there is a change in target temperature (S1005)” (YES in S1100), the process proceeds to S1200 and the control circuit portion 100 halts printing. At this time, the control circuit portion 100 halts printing after the fixing process of the page preceding the page that has been the target of the current judgement is complete. Thereafter, the control circuit portion 100 changes the target temperature (S1300) and restarts printing after the changeover of the target temperature is complete (S1400), and the process proceeds to S1500.

In S1100, in a case where the flow chart of FIG. 5 led to “there is no change in target temperature (S1002)” (NO in S1100), the control circuit portion 100 continues printing without changing the target temperature of the tandem fixing device 12, and the process proceeds to S1500.

In S1500, the control circuit portion 100 judges whether or not there is any next page. When there is a next page (YES in S1500), the process returns to S100, and the control circuit portion 100 repeats the processing of S1000 to S1500. In S1500, when there is no next page (NO in S1500), the control circuit portion 100 ends printing.

With the control as described above, the printing operation may be restarted and printing may be continued after the target temperature is changed during the printing.

In addition, a similar target temperature determining process may be performed at the start of a job, to thereby start printing after determining an optimal temperature control mode having a small number of target temperature changeovers in the job.

In this embodiment, the tandem fixing device 12 consisting of the two pairs of fixing rollers of the first fixing portion 12a and the second fixing portion 12b has been described as an example. However, also in a case of a fixing device consisting of one pair of fixing rollers, when the target temperature determining process described in this embodiment is applied to determine the fixing temperature, the same effects may be obtained.

As described above, the fixing target temperature is determined based on the information on the upper limit of basis weight and the lower limit of basis weight of each of the plain paper and the coat paper to be used in a job. Therefore, even when multiple types of paper are used, the need for the fixing temperature changeovers may be eliminated, or the number of the changeovers may be reduced. Even when there is a need for the fixing temperature changeovers, the fixing temperature capable of reducing the number of the subsequent fixing temperature changeovers as much as possible may be selected.

Therefore, appropriate fixing target control may be performed while avoiding the reduction in productivity.

According to this embodiment, the fixing target control may be performed in performing the fixing corresponding to the various types of paper.

According to this embodiment, even when multiple types of recording media are used in one print job, the number of the target temperature changeovers of the fixing device may be reduced as compared to the conventional technologies.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-114528, filed May 18, 2010, which is hereby incorporated by reference herein in its entirety.

What is claimed is:

1. An image forming apparatus, which forms an image on a recording medium, comprising:
an image bearing member;
a toner image forming portion configured to form a toner image on the image bearing member;
a transfer device configured to transfer the toner image formed on the image bearing member to the recording medium;
a fixing device configured to pressurize and heat the recording medium to which the toner image is transferred, to fix the toner image on the recording medium; and
a control circuit portion configured to control a temperature of the fixing device,
wherein the control circuit portion controls a temperature of the fixing device for a first recording medium based on the first recording medium and a second recording medium to be fixed after the first recording medium.

2. An image forming apparatus according to claim 1, further comprising an obtaining portion configured to obtain material information of the first recording medium and the second recording medium,
wherein the control circuit portion controls the temperature of the fixing device based on the material information.

3. An image forming apparatus according to claim 2, wherein the material information at least contains information on surfaceness and a basis weight of each of the first recording medium and the second recording medium.

4. An image forming apparatus according to claim 1, wherein the control circuit portion maintains the temperature of the fixing device unchanged when it is judged that fixing on the second recording medium may be performed by the fixing device with the temperature of the fixing device for the first recording medium.

5. An image forming apparatus according to claim 2, wherein the obtaining portion obtains material information on multiple recording media to be used in a print job, and the material information contains information on a maximum basis weight and a minimum basis weight for each material of the multiple recording media to be used in the print job.

6. An image forming apparatus according to claim 5, wherein the control circuit portion determines, in changing to a target temperature suitable for a next recording medium having a basis weight that is larger than a basis weight of a preceding recording medium, the target temperature with which fixing may also be performed on a recording medium having the maximum basis weight.

7. An image forming apparatus according to claim 5, wherein the control circuit portion determines, in changing to a target temperature suitable for a next recording medium having a basis weight that is smaller than a basis weight of a preceding recording medium, the target temperature with which fixing may also be performed on a recording medium having the minimum basis weight.

8. An image forming apparatus according to claim 5, wherein the temperature of the fixing device is changeable to multiple target temperatures,
wherein the multiple target temperatures are usable for fixing on recording media in predetermined ranges of basis weights, respectively,
wherein the predetermined ranges have an overlap, and
wherein the control circuit portion selects, in changing to a target temperature suitable for a next recording medium having a basis weight that is larger than a basis weight of a preceding recording medium, a lowest target temperature out of the multiple target temperatures with which fixing may also be performed on a recording medium having the maximum basis weight.
